(19) United States
(12) Patent Application Publication
(10) Pub. No.: US 2022/0066512 A1
(43) Pub. Date: Mar. 3, 2022

(54) FABRIC AND ELASTOMER LAYERS ON LAPTOPS

(71) Applicant: HEWLETT-PACKARD DEVELOPMENT COMPANY, L.P., SPRING, TX (US)

(72) Inventors: HUI HE, FORT COLLINS, CO (US); HUI LENG LIM, SPRING, TX (US); CHI HAO CHANG, TAIPEI CITY (TW); KUAN-TING WU, TAIPEI CITY (TW)

(21) Appl. No.: 16/763,446

(22) PCT Filed: Feb. 19, 2018
(86) PCT No.: PCT/US2018/018602

§ 371 Date: Aug. 20, 2021

(51) Int. Cl. G06F 1/16; B32B 15/06; B32B 25/10; B32B 7/12

(52) U.S. Cl. CPC G06F 1/1656; B32B 15/06; B32B 25/10; B32B 7/12; B32B 2250/03; B32B 2457/00; B32B 2255/06; B32B 2255/26; B32B 2255/20; B32B 2307/70; B32B 2255/02

(57) ABSTRACT

Examples include an apparatus comprising a laptop housing, an elastomer layer fixed on a surface of the laptop housing, and a fabric layer fixed on the elastomer layer.

### BACKGROUND

Laptops, notebooks, tablet computers, convertible devices, and smartphones (all of which are referred to herein as “laptops” for simplicity) have exterior surfaces that are handled by users and that may be subject to impacts. The exterior surface of a laptop may be formed of hard materials such as plastic, fiber composites, or metal alloys. For laptops with a hinged display, these exterior surfaces may also include rubber bumpers positioned between the laptop display and a keyboard surface of the laptop to cushion the impact of the display when closed.

### BRIEF DESCRIPTION OF THE DRAWINGS

Various examples will be described below referring to the following figures: FIG. 1 is a perspective view of a laptop with an elastomer and fabric layer in accordance with various examples.

FIG. 2 is a perspective view of a laptop with another elastomer and fabric layer in accordance with various examples.

FIG. 3 is a cross-section view of an elastomer and fabric layer in accordance with various examples.

FIG. 4 is a cross-section view of an additional elastomer and fabric layer in accordance with various examples.

### DETAILED DESCRIPTION

As explained above, some laptop surfaces are formed of hard materials, such as plastic, fiber composites, or metal alloys. These materials are often cold to the touch, non-tactile, and unstylish. In addition, because these surfaces are hard, in the case of a hinged laptop display, the surfaces may scratch or scuff the laptop display when a force is applied to the display in the closed position. For example, such scuffs may occur during a panel scuff test performed during the manufacturing process.

Examples described herein provide plastic, fiber composite, and alloy laptop surfaces that may be enhanced by bonding an elastomer layer to the exterior surface of the laptop and then bonding a fabric layer to the exterior of the elastomer layer. This fabric layer may be decorated or included colorful, printed designs. The fabric layer may also include an oleophobic layer on the exterior of the fabric layer to reduce the appearance of fingerprints that would otherwise appear due to user handling. These elastomer and fabric layers may provide style and user customization to a laptop, a more comfortable exterior surface, and protection against impacts or scuffing.

This disclosure first provides an overview of the positioning and use of multiple elastomer and fabric layers on a laptop. The disclosure then describes the configuration of example elastomer and fabric layers suitable for use on the various materials that may form the exterior of a laptop housing. In general, an elastomer layer and a fabric layer are bonded to a portion of the exterior of a laptop housing such that the fabric layer forms a portion of an exterior surface of the laptop.

FIG. 1 shows an example laptop 100. Laptop 100 includes a housing 120. While FIG. 1 depicts a laptop with a display 140 that is hingedly connected along an edge 190 of the housing 120, unless otherwise indicated, a “laptop” in accordance with this disclosure also encompasses a notebook or a tablet computer, a convertible or 2-in-1 computing device, or a smartphone with a display that is integral with the housing or that is otherwise not hingedly connected to the housing 120.

The housing 120 of laptop 100 includes a lower portion 130 having an exterior surface. Elastomer and fabric layers may be positioned at various locations on the exterior surface of the housing 120, including on the lower portion 130, as shown in FIG. 1 adjacent to the keyboard 110. When the laptop 100 has a display 140 that is hingedly connected to the housing 120, elastomer and fabric layer 150 may be positioned to form an elastic cushion between the display 140 and the lower portion 130 of housing 120. In this manner, the fabric and elastomer layer 150 may beneficially prevent the display 140 from being scratched or scuffed by rubbing against the hard exterior surface of a plastic, fiber composite, or metal alloy housing 120, such as when the display 140 is rapidly closed, or when the laptop 100 undergoes scuff testing as a part of the manufacturing process. In this manner, the laptop 100 may not use a separate rubber bumper, such as bumper 170, in order to cushion the display 140 when it is closed.

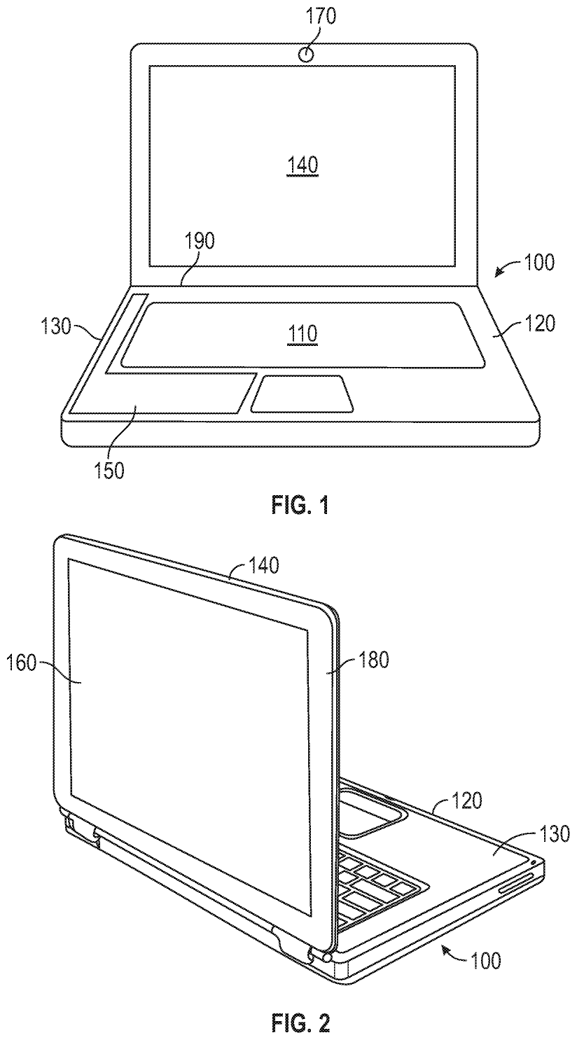

FIG. 2 illustrates one of the multiple other positions in which elastomer and fabric layers may be located on a laptop 100. As shown in FIG. 2, display 140 has a back surface 180 that normally faces away from a user. Elastomer and fabric layers 160 may be located on the back surface 180 of display 140 to cushion potential impacts, help secure the laptop when carried, and to enhance style or appearance. When used on a convertible or 2-in-1 device, fabric layers 160 may also provide a cushion to protect the back surface 180 and the keyboard 110 against scuffs and scrapes when the display 140 is flipped around so as to operate the device in a tablet mode. While not shown in the drawings, elastomer and fabric layers may also be located on the sides of the laptop 100 to offer impact protection, and on the bottom of the laptop 100 to offer protection from heat.

Elastomer and fabric layers may be located in areas not specifically identified in FIGS. 1 and 2. For example, in FIG. 1, elastomer and fabric layers may be positioned in other areas around the perimeter of the keyboard 110 or around the perimeter of the display 140. In general, the elastomer and fabric layers may be positioned in any desired area(s) of the laptop 100, regardless of whether the laptop 100 is a laptop computer, a notebook computer, a convertible or 2-in-1 device, a tablet computer, or a smartphone.

This disclosure now provides several examples of elastomer and fabric layers that may be suitable for the various materials that are used to form the exterior of a laptop housing.

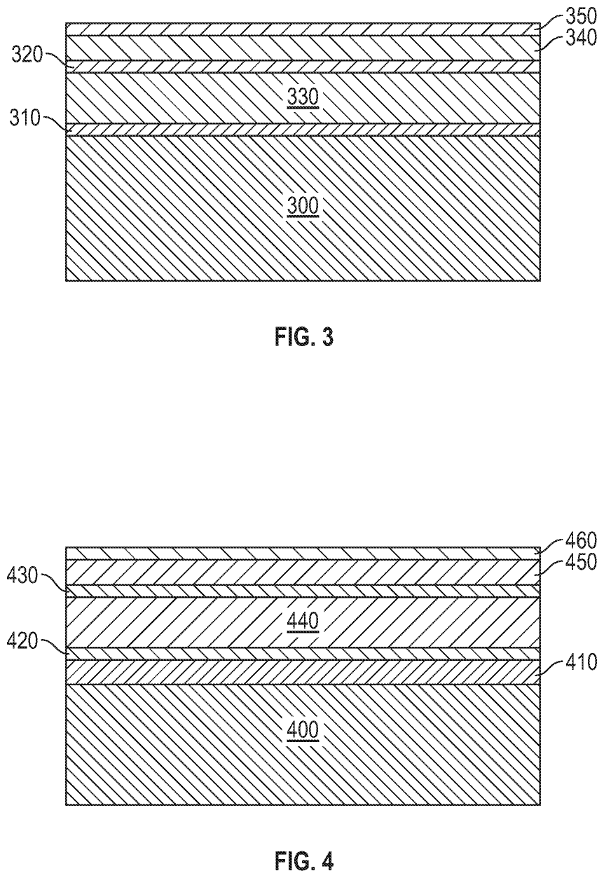

FIG. 3 is a cross-section of an example elastomer and fabric layer on a laptop housing that is made from a plastic or a fiber composite material (e.g., carbon fiber composite). Here, the exterior of the laptop housing 300 includes a first bonding or adhesive layer 310, an elastomer layer 330, a second bonding or adhesive layer 320, a fabric layer 340, and an optional oleophobic anti-fingerprint layer 350. By way of example, the bonding or adhesive layers 310 and 320 may have thicknesses of 10-30 microns, the elastomer layer 330 may have a thickness of 25-200 microns, the fabric layer 340 may have a thickness of 15-50 microns, and the oleophobic anti-fingerprint layer 350 may have a thickness of 15-100 nanometers.

When the laptop housing 300 is formed from a molded plastic or fiber composite material, it may be efficient to create the bonding or adhesive layers 310 and 320, the elastomer layer 330, and the fabric layer 340 using an in-mold decoration process. Using such an in-mold decoration process, the layers 310-340 may be advantageously created at the same time as the molded laptop housing 300.

FIG. 4 depicts an additional example of elastomer and fabric layers, this time on a metal alloy laptop housing 400. Examples of metal alloys include alloys of aluminum, magnesium, and titanium. When metal alloys are used, it may be helpful to employ a passivation layer 410 between the alloy layer 400 and a bonding or adhesive layer 420. By way of example, the passivation layer 410 may be an anodizing layer or a microarc oxidation (MAO) layer. Such a passivation layer 410 helps form a stronger bond between the alloy layer 400 and an elastomer layer 440.

The thicknesses of the different layers used on an alloy laptop housing are similar to the thicknesses of the layers used on a plastic or fiber composite laptop housing. For example, bonding or adhesive layers 420 and 430 may have a thickness of 10-30 microns, the elastomer layer 440 may have a thickness of 25-200 microns, a fabric layer 450 may have a thickness of 15-50 microns, and an oleophobic anti-fingerprint layer 460 may have a thickness of 15-100 nanometers. The passivation layer 410, when comprising an oxide or nitride layer, may have a thickness of 1-5 microns. The passivation layer 410, when comprising a microarc oxidation layer, may have a thickness of 3-15 microns. The passivation layer 410, when comprising an anodizing layer, may have a thickness of 5-25 microns.

Useful materials for fabric layers 340 and 450 include cellulose, nylon, polyester, acrylic, cotton, Jute, and Rayon.

Useful materials for elastomer layers 330 and 440 include chloroprene rubber, polyisoprene, polybutadiene, butyl rubber, styrene-butadiene rubber, nitrile rubber, hydrogenated nitrile rubbers, EPM (ethylene propylene rubber) and EPDM rubber, silicone rubber, fluorosiliconerubber, fluoroelastomers, perfluoroelastomers, polyether block am ides (PEBA), chlorosulfonatedpolyethylene, ethylene-vinyl acetate (EVA), and polysulfide rubber, thermoplastic urethane, and thermoplastic elastomers.

Useful adhesives for the bonding or adhesive layers 310, 320, 420, and 430 include ethylene vinyl acetate, ethylene-ethyl acrylate, ionomers, ethylene acrylate, Phenoxies, Polyam ides, Polyesters, polyvinyl acetate, and polyvinyl butyraland polyvinyl ethers.

Each of the examples described herein may also include an oleophobic anti-fingerprint layer on top of the fabric layer. This layer may comprise a fluoropolymer coating selected from fluorinated olefin-based polymers, specialty fluoroacrylates, fluorosilicone acrylates, fluorourethanes, perfluoropolyethers/perfluoropolyoxetanes, fluorotelomers (C-6 or lower products), polytetrafluoroethylene (PTFE), polyvinylidenefluouride (PVDF), fluorosiloxane, fluoro UV polymers and hydrophobic polymers (C-7 or longer).

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An apparatus comprising:
a laptop housing;
an elastomer layer fixed on a surface of the laptop housing; and
a fabric layer fixed on the elastomer layer.

2. The apparatus of claim 1 wherein the laptop housing has a metal alloy exterior, and wherein the apparatus includes a passivation layer positioned between the metal alloy exterior and the elastomer layer.

3. The apparatus of claim 2 wherein:
the passivation layer is an anodizing layer or a microarc oxidation layer;
the elastomer layer is bonded on the passivation layer; and
the fabric layer is bonded on the elastomer layer.

4. The apparatus of claim 3 including an oleophobic layer on the fabric layer.

5. The apparatus of claim 1 wherein:
the laptop housing has a plastic or fiber composite exterior;
the elastomer layer is bonded on the plastic or fiber composite exterior; and
the fabric layer is bonded on the elastomer layer.

6. The apparatus of claim 5 wherein the elastomer layer and the fabric layer are formed by in-mold decoration of the laptop housing.

7. The apparatus of claim 5 including an oleophobic layer on an exterior of the fabric layer.

8. An apparatus comprising:
a laptop housing;
a display hingedly connected to a first edge of the laptop housing, wherein the display is to close toward a surface of the laptop housing;
an elastomer layer bonded on the surface of the laptop housing; and
a fabric layer bonded on the elastomer layer such that the display is to close toward the fabric layer.

9. The apparatus of claim 8 wherein:
the laptop housing has a metal alloy exterior and an anodizing layer or a microarc oxidation layer formed on an exterior of a portion of the housing; and
the elastomer layer is bonded on the anodizing layer or microarc oxidation layer.

10. The apparatus of claim 8 wherein:
the laptop housing is molded and has a plastic or fiber composite exterior;
the elastomer layer is bonded on the plastic or fiber composite exterior; and
the elastomer layer and the fabric layer are formed by in-mold decoration of the laptop housing.

11. The apparatus of claim 8 including an oleophobic layer on the fabric layer.

12. An apparatus comprising:
a laptop display having a screen surface and an opposing back surface;
an elastomer layer bonded on the back surface; and
a fabric layer bonded on the elastomer layer.

13. The apparatus of claim 12 wherein:
the back surface includes a metal alloy with an anodizing layer or a microarc oxidation layer; and
the elastomer layer is bonded on the anodizing layer or microarc oxidation layer.

14. The apparatus of claim 12 wherein:
the back surface is molded and has a plastic or fiber composite exterior; and
the elastomer layer is bonded on the plastic or fiber composite exterior.

15. The apparatus of claim 12 including an oleophobic layer on the fabric layer.
